(19) United States
(12) Patent Application Publication
(10) Pub. No.: US 2007/0142036 A1
(43) Pub. Date: Jun. 21, 2007

(54) Provision of content in mobile environments

(75) Inventors: Johan Wikman, Helsinki (FI); Ferenc Dosa, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/303,378

(22) Filed: Dec. 16, 2005

(51) Int. Cl. H04Q 7/22

(52) U.S. Cl. 455/414.1

(57) ABSTRACT

A method for providing content to a remotely located electronic device, which may be connectable to the Internet, by accessing content on a device (e.g. an Internet server) located near a mobile intermediate device by using the mobile intermediate device (another Internet server) as a “through conduit.” The intermediate device detects other devices in its proximity, lists the detected devices, detects a request to access at least one of the listed Internet servers, and forwards the access request to the listed Internet servers to be accessed. The remote device does not need to know the original content address.

### FIELD OF THE INVENTION

The present invention relates to improvements in or relating to the provision of content in mobile environments. Certain embodiments relate to improvements related to the provision of content using Internet web browsing in mobile environments.

The present invention encompasses appropriately modified equipment including intermediate (Internet/intranet) devices, origin (Internet/intranet) devices, and client devices, together with corresponding network systems encompassing such equipment. The present invention also encompasses appropriately modified modules for such equipment. Methods of operating such equipment/modules/networks, and appropriately modified software code are also within the scope of the present invention.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

As used herein, the term “server” relates to electronic equipment that is used for managing network resources. The term “web server” relates to a server that manages one or more websites. The web server may store some or all the website content within the web server equipment, or in one or more pieces of equipment which is separate to the web server but to which the web server has access.

The term “client device” refers to electronic equipment which is used to provide user access to a network, such as the Internet or an intranet. Client devices encompass, for example, a laptop/desktop computer, a Personal Digital Assistant (PDA), and a mobile phone, and are used to provide the user of the client device access to network resources, such as a website.

The term “origin device” is used to refer to electronic equipment which manages (and may contain) originating resources for use by another device in the network. In the case of an origin web server, the origin web server may provide website access to a website which is managed by the origin web server.

The term “intermediate device” refers to electronic equipment which provides connection of a client device to an origin device via (i.e. through) the intermediate device.

The aforementioned electronic equipment may comprise cellular transmission circuitry, for example a GSM engine and/or Personal Area Network (PAN) circuitry, for example a Bluetooth™ and/or Wireless Local Area Network (WLAN) engine.

The World Wide Web (WWW or simply Web) is an information network where the items of interest, referred to as resources, are identified by global identifiers called Uniform Resource Identifiers (URIs). A URI identifies a particular source but does not indicate how to locate it. A URI is the generic term for all types of names and addresses that refer to objects on the Web.

A Uniform Resource Locator (URL) is one kind of URI. For locating the resource, a URL is needed. The URL is the global address of documents and other resources on the World Wide Web. The first part of the address indicates what protocol to use, and the second part specifies the Internet Protocol (IP) address or the domain name/address where the resource is located.

For example, the two URLs below point to two different files at the domain “nokia.com”. The first specifies an executable file that should be fetched using the FTP protocol; the second specifies a Webpage that should be fetched using the HTTP protocol:
ftp://www.nokia.com/stuff.exe
http://www.nokia.com/index.html

The Web is a service that operates over the Internet. Computers connected to the Internet transmit data by packet switching using a standardized Internet Protocol (IP) and many other protocols. The abbreviation TCP/IP (Transmission Control Protocol/Internet Protocol) refers to the suite of communication protocols to connect hosts (e.g. client device computers) on the Internet. TCP/IP uses several protocols, the two main ones being TCP and IP.

The IP address is an identifier for a computer or device on a TCP/IP network. Networks using the TCP/IP protocol route messages based on the IP address of the destination. The format of an IP address is a 32-bit numeric address written as four numbers separated by periods. Each number can be zero to 255. For example, 1.160.10.240 could be an IP address.

Within an isolated network, one can assign IP addresses at random as long as each one is unique. However, connecting a private network to the Internet requires using registered IP addresses (called Internet addresses) to avoid duplicates. Such IP addresses can be considered to be global addresses.

The term Internet server can be considered to relate to electronic equipment that manages Internet network resources. A web server which provides access to its' resources via the Internet is one type of Internet server. For accessing a web server, a user needs to know some identification information, such as a web address or domain name of the server to be accessed.

Internet servers are normally fixed to a certain geographical location, but in the future, the number of mobile Internet servers is likely to increase. With mobile Internet servers, a situation may occur where one mobile Internet server is surrounded by many other fixed and/or mobile Internet servers. A user may want to access several of these mobile Internet servers, but this usually requires knowing the address of each server to be accessed.

There may be situations where the user only knows how to access one of these servers, but he may also want to access the other servers that are in the proximity of the known server without having any a-priori knowledge about them. There is a therefore a need for accessing content on an origin device (e.g. Internet server) using a client device via a mobile intermediate device (e.g. Internet server), with the knowledge of how to access the intermediate device, but without knowing the specific access information of the origin device to access it directly. In this way, a client device can access the content (e.g. website, or other content) contained on an origin device via the intermediate device.

### SUMMARY OF THE INVENTION

In a first aspect, the present invention provides a mobile intermediate device for providing content from a geographically proximate origin device to a geographically remote client device, the mobile intermediate device having a mobile intermediate device address to which content requests are communicated from the client device, and mobile intermediate device comprising an input and an output, the output arranged to provide content to a remote client device upon receipt of a content request at the input from the remote client device. Near field connectivity circuitry is used to maintain connectivity with one or more origin devices located geographically proximate to the mobile intermediate device to provide access to content from one or more of the respective origin devices. A processing unit is arranged to provide an indication to the client device of content on one or more geographically proximate origin devices; receive a request from the client device, via the input, addressed to the mobile intermediate device address, of user selected content from one or more origin devices; and obtain the user selected content from the respective origin device using the near field connectivity circuitry, and provide the user selected content from the origin device to the client device via the mobile intermediate device using the mobile intermediate device address as the source for the content.

The mobile intermediate device address may be the Internet domain address of the mobile intermediate device, and the source address for the content may be a sub-domain address of the Internet domain address. The mobile intermediate device may comprise a web server and the mobile intermediate device address may be the web server address, and the content request may be addressed to the web server. The mobile intermediate device address may be a telephone number. The mobile intermediate device may be arranged to function as a reverse proxy server. The mobile intermediate device address may be globally or locally unique. The mobile intermediate device may comprise wireless transmission circuitry for transmission of requests and content between the mobile intermediate device and the client device.

The near field connectivity circuitry may comprise circuitry to provide wireless connectivity between an origin device and the mobile intermediate device. The near field connectivity circuitry may be arranged to maintain connectivity intermittently over a particular connection period. The near field connectivity circuitry may be arranged to maintain connectivity continuously over a particular connection period. The processing unit may comprise one or more processors.

In a second aspect, the present invention provides a network system comprising a mobile intermediate device as defined previously. In a third aspect, the present invention provides a mobile intermediate device module comprising the input, output, and processing unit as defined previously.

In a fourth aspect, the present invention provides a method of providing content using a mobile intermediate device, the mobile intermediate device for providing content from a geographically proximate origin device to a geographically remote client device, the mobile intermediate device having a mobile intermediate device address to which content requests are communicated from the client device. The method comprises providing a request, from the client device, addressed to the mobile intermediate device address of user selected content from one or more origin devices;

providing the user selected content from the respective origin device using near field connectivity between the mobile intermediate device and the respective geographically proximate origin device from which the user selected content is sourced; and providing the user selected content from the respective origin device to the client device via the mobile intermediate device using the mobile intermediate device address as the source for the content. The method may be performed using the Internet. The invention also encompasses appropriately modified software code stored on an appropriate medium. The present invention encompasses one or more previously or subsequently mentioned aspects and/or embodiments in all various combination whether or not specifically stated in that combination.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the present invention will, by way of example, be described with reference to the following Figures, in which:

FIG. 1 illustrates an environment in which a remote server can be accessed via an intermediate server;

FIG. 2 is a schematic block diagram illustrating a mobile Internet server according to an embodiment of the invention; and

FIG. 3 is a flow chart illustrating a method according to an embodiment of the invention.

### DETAILED DESCRIPTION OF EMBODIMENTS OF THE INVENTION

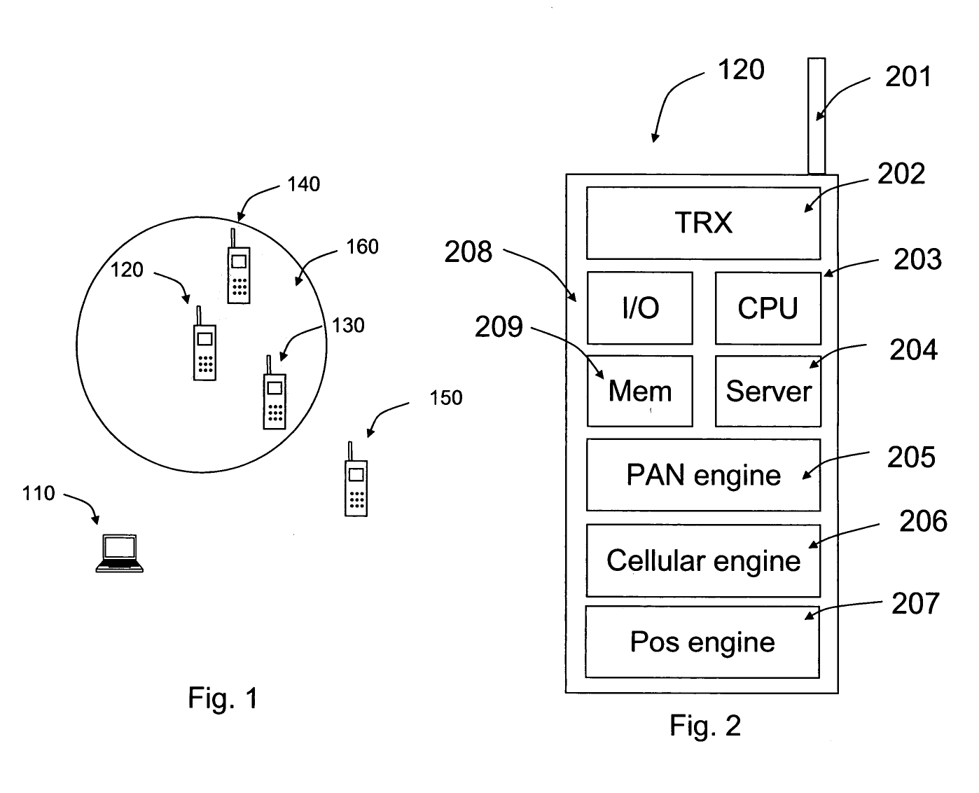

FIG. 1 illustrates an operational environment of some embodiments of the present invention. In FIG. 1, there is shown an electronic client device 110, in this case a desktop computer. The electronic client device 110 has capabilities to access the Internet. The electronic client device 110 could also be, for instance, a PDA, laptop, mobile phone or any other electronic device having communication capabilities that enable accessing the Internet.

FIG. 1 also shows other electronic devices 120, 130, 140 and 150. These are located remote to the electronic client device 110. In this case, all the electronic devices 120, 130, 140 and 150 have communication capabilities for accessing the Internet. In this particular example, the electronic devices 120, 130, 140 and 150 represent cellular mobile phone handsets which can also act as Internet web servers, and thus themselves also manage content for use on the Internet. Thus, they can provide access to their respective websites through their cellular transmission/communication circuitry.

The electronic device 120 is a user portable mobile intermediate device. It is used to provide through-connection of client device 110 with one or more electronic devices 130, 140, 150 which come into the vicinity/geographical proximity (e.g. 160) of intermediate device 120.

One or more of electronic devices 130, 140, 150 could be geographically fixed or mobile devices, but in the specific example shown in FIG. 1, all of these devices are mobile cellular devices which are user portable. They can be considered to be origin devices as they contain (or at least manage) originating content.

The electronic devices 110, 120, 130, 140 and 150 are capable of transmitting and receiving data by packet switching using a standardized Internet Protocol (IP) and possibly also other protocols. As mentioned above, the electronic devices 110, 120, 130, 140 and 150 each comprise mobile Internet web servers, each of which can be independently remotely accessed directly by using a URL, globally unique for each handset. However, in other embodiments, one, more, or all of the devices 120, 130, 140, 150 may not have a global URL, but may only be accessible through a locally unique assigned address.

In this specific example, independent remote direct access of, for example, electronic origin device 130 by client device 110 is through the Internet via the cellular transmission circuitry comprised in device 130.

Shaded area 160 describes a proximity area of the handset 120. The radius of the proximity area 160 can be defined, for instance, to be the operative range of the near field communication circuitry comprised in the handset 120. The near field communication circuitry may be compatible with Bluetooth™ or WLAN standards. Other ways to define the proximity area 160 exist, and the proximity area 160 does not have to be of a circular shape.

The handsets 120, 130, 140 and 150 can communicate with each other using, for instance, Bluetooth™, providing the handsets 130, 140 and 150 are within the area 160 of the used near field communication circuitry comprised in intermediate device 120 (and if devices 130, 140, 150 contain such near field communication circuitry). In the example shown in FIG. 1, the origin device 150 is outside the proximity area 160 (vicinity) of intermediate device 120.

FIG. 2 is a schematic block diagram of the mobile phone handset 120 of FIG. 1. One, more or all of the handsets 130, 140, 150 may be similarly configured. In this example, the handset 120 functions as a cellular telephone according to GSM. However, for example, the handset may be configured to be compatible with one or more of the following telecommunications standards: GPRS, EDGE, HSCSD, UMTS, CDMA 2000, IS95, etc.

For receiving and transmitting signals, the handset 120 includes an antenna 201. Two or more separate antennas could also be used, but in this embodiment the same antenna can receive and transmit signals of Bluetooth™, cellular and positioning systems (e.g. GPS). The handset also includes a transceiver unit/module 202 (TRX).

The handset 120 also includes a personal area network (PAN) engine 205, in this case a Bluetooth™ engine for providing Bluetooth™ communication capabilities. For cellular communication, the handset 120 includes a cellular engine 206.

The handset 120 is shown to include a positioning engine 207 (pos engine). The positioning engine uses the information received, for instance, from the satellites in order to calculate the location of the handset 120. However, the handset 120 need not comprise the positioning engine 207 to put the present invention into effect.

The handset 120 includes a central processing unit/module 203 (CPU) for centrally controlling the functioning of the handset 120. The CPU can comprise one or more processing units depending on the implementation of the handset 120. As is customary, the handset 120 also comprises a memory (Mem) 209. The memory may have random access (RAM) and read only memory (ROM) parts. Suitable data can be stored in that memory.

As mentioned above, the handset 120 can function as an Internet server, in this case as a web server, and comprises associated server circuitry 204. The web server can be directly accessed by other terminals in the Internet via a global domain name address.

The handset 120 contains input/output (1/0) circuitry 208. Input circuitry may be, for instance, arranged to provide keyboard, touch pad, or touch screen user interface functions. A microphone may also be provided as an input means for receiving voice information. Output circuitry may be provided, for instance, by a display, such as a liquid crystal display (LCD). A loudspeaker may also be provided for outputting speech or sound. Other suitable input/output circuitry are also possible.

The following is a specific practical example of the present invention in use. This is followed by details of how the present invention may be put into effect. In this example, Jussi is currently doing a late shift in the office because his manager ordered him to do so without any notice. Jussi was meant to be going out in the evening with his friend Bill to get acquainted with Bill's friends—Kate, David and Brian. In the evening, Jussi stays in the office and has access to client device 110.

Bill is out in the evening with Kate, David and Brian. Bill, Kate, David and Brian each have a mobile handset with a web server. In the example show in FIG. 1, Bill's mobile handset can be considered to be the intermediate device 120, Kate's handset device 130, David's handset device 140 and Brian's handset device 150.

Bill, Kate, David and Brian all have cameras on their handsets and they can take photos/video clips and then save them on their respective devices. Their handsets, which comprise web server circuitry, contain their personal websites and are configured to allow the photos/video clips to be saved and accessed by browsing their personal web sites. The handsets can also configured to allow the photos/video clips to be accessed independently of their personal websites by an authorized third party, e.g. by Bluetooth™ connection with another device. Throughout the evening, Bill, Kate, David and Brian take photos/video clips and save them to their respective handsets.

Jussi knows Bill well, and thus knows the domain name (e.g. http://bill.mobileuser.com) of Bill's personal website. Bill's website is contained on Bill's device 120. Jussi can type the known domain name “http://bill.mobileuser.com” on the web browser on client device 110 to access Bill's website. As Bill has been saving his photos/video clips in sub-domain “/camera”, Jussi can enter “http://bill.mobileuser.com/camera” into the web browser on client device 110 to directly access the stored camera data.

Bill would like to allow Jussi to view camera data stored on Kate's handset 130, David's handset 140 and Brian's handset 150. With their permission, Bill makes a Bluetooth™ connection with their respective devices 130, 140, 150. To start with, all these devices are in the proximity area 160 of Bill's device 120 (not shown in FIG. 1).

In this case, all of the camera data which is generated during the evening is stored to be independently accessible from their respective devices directly via their personal web domains http://kate.mobileuser.com, http://david.mobileuser.com and http://brian.mobileuser.com, each respectively contained on handsets 130, 140, and 150. However, Jussi does not have these details. To allow Jussi to have access to the camera data on the handsets 130, 140, 150, Bill's handset is configured to provide access to the camera data via a sub-domain of Bill's website, for example, http://bill.mobileuser.com/neighbourhood/kate or http://bill.mobileuser.com/neighbourhood/brian.

Bill's handset 120 acts as an intermediary device and allows access by Jussi's client device 110 to handsets 130, 140, 150 via the Bluetooth™ connection while the Bluetooth™ connection is maintained. If the Bluetooth™ connection is lost, for example, between Bill's intermediary device 120 and Brian's handset 150 as shown in FIG. 1, then Jussi is no longer able to access the camera data on Brian's handset 150.

Instead of indicating the full domain names of the origin devices 130, 140, 150, Bill's handset 120 could use an abbreviation. For example, Bill could set up his handset 120 such that Kate's website is in sub-domain “a”. Thus, if Jussi were to click on “a” in Bill's website, then Jussi would be to browse http://bill.mobileuser.com/neighbourhood/a, which is identical, in this example, with what Jussi would obtain by browsing directly to http://kate.mobileuser.com, providing Jussi would already know Kate's URL beforehand.

However, if Kate's web server did not have a global domain name, but was only accessible over Bluetooth™, then her website would only be accessible to Jussi when 1) Jussi is in her proximity, 2) she is in the proximity of a web server with a global URL (i.e. Bill's). Access via Bill's intermediary device can be conveniently provided by using dynamic reverse proxy, as is discussed below.

By Jussi clicking on any of the listed names on Bill's neighborhood, Bill would allow Jussi to implicitly browse those web sites in the proximity of Bill, even if it appears as if the content would be coming straight from Bill's web site.

In another embodiment, Bill's handset may be configured to use RFID technology. In this embodiment, a bar Bill is visiting may have an RFID tag at the entrance. When Bill briefly touches the RFID tag with his handset 120, this provides the domain name of the bar's website to Bill's handset 120 and allows Bill's handset to provide access to the bar's website via Bill's website i.e. via a sub-domain of Bill's website. In this way, Jussi can identify the bar in question and join Bill and his friends if he manages to finish at work in time.

In another embodiment, the bar has WLAN coverage and the PAN engine 205 of Bill's handset 120 comprises WLAN circuitry. In this case, access to the Internet web server on Bill's handset is via WLAN and not the cellular network. When Bill touches his handset on the RFID tag, the WLAN provides information to the Internet to allow communications to be routed to Bill's handset via the bar WLAN. While Bill is in the neighborhood of the bar, the web server on Bill's handset 120 can be accessed, and thus also the web sites of Kate, David and Brian, at least while Kate, David and Brian are within the proximity of Bill (which may be determined using Bluetooth™ or WLAN, including the WLAN of the bar).

In a further embodiment, the touching of the contact between the bar RFID tag and the handset 120 may initiate a WLAN connection between the access point of the bar and the handset 120. While Bill is within the WLAN of the bar, he has a connection to the bar access point, and thus can, for example, provide a link to the bar's website to Jussi, via the cellular network, but while using the WLAN connection to connect to the bar's website. Once Bill moves away from the bar WLAN, the link for Jussi, via Bill's handset 120, to the bar's website is lost.

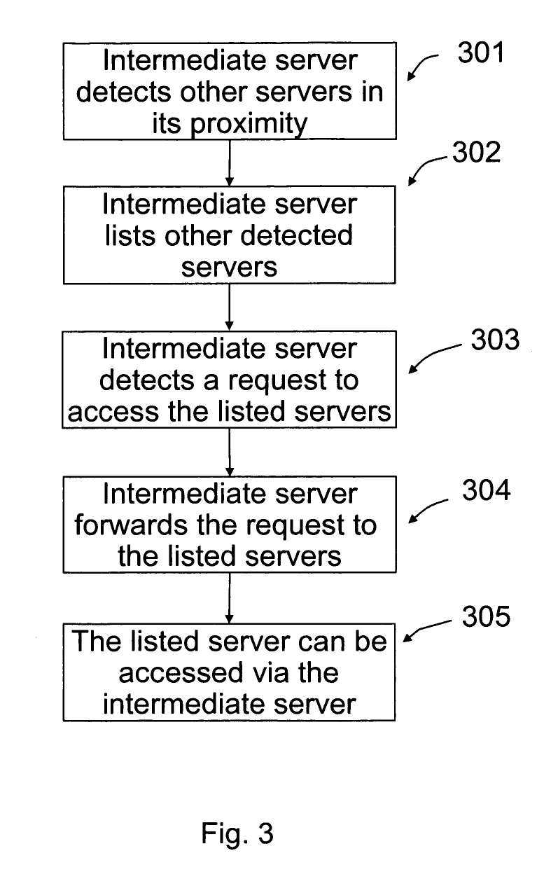

The following discusses details of messaging between electronic equipment arranged to perform the present invention. FIG. 3 illustrates a flow chart of a method for accessing a remote Internet origin web server via an intermediate Internet web server. A general description is provided below, along with the relevant method steps.

At step 301, the handset 120, which in this case acts as an intermediate web server, detects other origin servers that are in its proximity. This is done by, for example, performing Bluetooth™ searches for devices in its proximity with web server capability.

At step 302, the intermediate web server 120 identifies and stores a sub-domain link to at least some of the detected (web) servers that are in its proximity. These links are provided to be selected via the web server 120 by a client device 110 accessing the Internet.

At 302, the handset 120 creates a list of the detected web servers. However, all the detected web servers do not necessarily have to be listed. The handset 120 generates a name for each web server that needs to be listed. The listed servers could be enumerated, for instance, as A, B, C, etc, or there could be a specific mechanism in which the servers could be queried for the name under which they want to be listed. This could be done in the same way as web browsers can query for the small icon to be shown in the browser URL bar. This means that the handset 120 can access a particular link on the website of the detected device. This link could be for instance /my_name on the detected web server. If a response is returned, then that is used as the name for the detected site. Or then there could be a more advanced solution based on a web service interface.

The user of the electronic device 110 types the URL of the handset 120 on the URL field of the electronic device 110. After this the user of the electronic device 110 can browse the web page provided by the handset 120. The user of the electronic device 110 can now also browse the list which contains names of the detected and listed web servers that are in the proximity of the handset 120. The user of the electronic device 110 must now decide which of the listed web servers he wants access. In this case the user of the electronic device 110 wants to browse the web page provided by the remote handset 140.

In due course, at step 303, the intermediate server (handset 120) detects a request sent by the electronic device 110 to access one or many of the identified servers. In this specific example, it is the electronic device 110 that sent the access request, but it could also be any other device having access to the Internet. The user of the electronic device 110 only knows the URL of the handset 120 but does not know the URL of the remote (i.e. origin) handset 140. At the beginning of the communication session, the user of the electronic device 110 does not necessary even know that the handset 140 is in the proximity of the handset 120.

At step 304, the handset 120 forwards the access request sent by the user of the electronic device 110 to the remote handset 140. Thus the intermediate server, in this case the handset 120, is configured to act as a reverse proxy. The access request can be forwarded by using, for instance, any suitable near field communication technique, such as Bluetooth™. The mobile web server 204 in device 120 acts as a dynamic reverse proxy for other web servers that happen to be in proximity.

Then at step 305, the remote handset 140 can be accessed by the user of the electronic device 110. Now the user of the electronic device 110 can browse the web page provided by the remote handset 140 via the handset 120.

Reverse proxy techniques can be conveniently used to implement the invention. An ordinary forward proxy is an intermediate server that sits between the client and the origin server. In order to get content from the origin server, the client sends a request to the proxy naming the origin server as the target and the proxy then requests the content from the origin server and returns it to the client. The client must be specially configured to use the forward proxy to access other sites.

A server configured as a reverse proxy, by contrast, appears to the client just like an ordinary web server. No special configuration on the client is necessary. The client makes ordinary requests for content in the name-space of the reverse proxy. The reverse proxy then decides where to send those requests, and returns the content as if it was itself the origin.

It will be appreciated that in accordance with the present invention, the electronic device 110 can access the content on electronic devices 130 and 140 via the electronic device 120 without knowledge of the URLs of the electronic devices 130 and 140 as long the electronic devices 130 and 140 are in the proximity of the electronic device 120 and the URL of the electronic device 120 is known.

The URLs of devices 130, 140 and 150 may be permanently fixed, but may change over time. The URLs of the electronic devices 130, 140 and 150 may not be global. The content is remotely accessed by client device 110 via mobile device 120 by using a near field communication technique between mobile device 120 and devices 130, 140, 150.

The invention also relates to a corresponding software code, which can be used to implement at least some parts of the method according to the embodiments described above. The invention equally relates to a corresponding software program product in which a software code can be stored.

In the handset 120 all inventive features could be incorporated into a single module. The module should comprise circuitry for implementing the method described above.

The invention also relates to the handset 120 acting as an intermediate server, which comprises the module described above.

Finally, the invention relates to a network system in which the handset 120 can be used. The network system comprises at least an intermediate device, at least one remote origin device in its proximity, and a client device used to access the content on the remote device via the intermediate device.

It is to be noted that the described embodiments can be varied in many ways and that these are just exemplary embodiments of the invention. For example, in the specific examples discussed, intermediate device 120 is accessible to the client device 110 through the Internet and thus provides sharing of content via the Internet. However, in other embodiments, the sharing of content does not have to be via the Internet. It could be that sharing of content is provided by non-Internet cellular communication between the client device 110 and the mobile intermediate device. For example, sound files could be shared from origin device 130 to client device 110 via intermediate device 120 without using the Internet but using cellular transmission.

Furthermore, the content on the devices 130, 140, 150 may or may not be for access via the Internet. They could be for access via an intranet, or via near field communication techniques between two or more devices. The content may be executable files. The mobile intermediate device may not be user portable but may be fixed to a mobile vehicle.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A mobile intermediate device for providing content from a geographically proximate origin device to a geographically remote client device, the mobile intermediate device having a mobile intermediate device address to which content requests are communicated from the client device, comprising:
an input and an output, the output arranged to provide content to a remote client device upon receipt of a content request at the input from the remote client device;
near field connectivity circuitry to maintain connectivity with one or more origin devices located geographically proximate to the mobile intermediate device to provide access to content from one or more of the respective origin devices; and
a processing unit, wherein the processing unit is arranged to
provide an indication to the client device of content on one or more geographically proximate origin devices;
receive a request from the client device, via the input, addressed to the mobile intermediate device address, of user selected content from one or more origin devices; and
obtain the user selected content from the respective origin device using the near field connectivity circuitry, and provide the user selected content from the origin device to the client device via the mobile intermediate device using the mobile intermediate device address as the source for the content.

2. A mobile intermediate device as claimed in claim 1, wherein the mobile intermediate device address is the Internet domain address of the mobile intermediate device, and wherein the source address for the content is a sub-domain address of the Internet domain address.

3. A mobile intermediate device as claimed in claim 1, wherein the mobile intermediate device comprises a web server and the mobile intermediate device address is the web server address, and wherein the content request is addressed to the web server.

4. A mobile intermediate device as claimed in claim 1, wherein the mobile intermediate device address is a telephone number.

5. A mobile intermediate device as claimed in claim 1, wherein the mobile intermediate device is arranged to function as a reverse proxy server.

6. A mobile intermediate device as claimed in claim 1, wherein the mobile intermediate device address is globally unique.

7. A mobile intermediate device as claimed in claim 1, wherein the mobile intermediate device address is locally unique.

8. A mobile intermediate device as claimed in claim 1, wherein the mobile intermediate device comprises wireless transmission circuitry for transmission of requests and content between the mobile intermediate device and the client device.

9. A mobile intermediate device as claimed in claim 1, wherein the near field connectivity circuitry comprises circuitry to provide wireless connectivity between a origin device and the mobile intermediate device.

10. A mobile intermediate device as claimed in claim 1, wherein the near field connectivity circuitry is arranged to maintain connectivity intermittently over a particular connection period.

11. A mobile intermediate device as claimed in claim 1, wherein the near field connectivity circuitry is arranged to maintain connectivity continuously over a particular connection period.

12. A mobile intermediate device as claimed in claim 1, wherein the processing unit comprises one or more processors.

13. A network system comprising a mobile intermediate device as claimed in claim 1.

14. A mobile intermediate device module, comprising:
an input and an output, the output arranged to provide content to a remote client device upon receipt of a content request at the input from the remote client device; and
a processing unit, wherein the processing unit is arranged to
provide an indication to the client device of content on one or more geographically proximate origin devices;
receive a request from the client device, via the input, addressed to the mobile intermediate device address, of user selected content from one or more origin devices; and
obtain the user selected content from the respective origin device using the near field connectivity circuitry, and provide the user selected content from the origin device to the client device via the mobile intermediate device using the mobile intermediate device address as the source for the content.

15. A method of providing content using a mobile intermediate device, the mobile intermediate device providing content from a geographically proximate origin device to a geographically remote client device, the mobile intermediate device having a mobile intermediate device address to which content requests are communicated from the client device, comprising
providing a request from the client device, addressed to the mobile intermediate device address, of user selected content from one or more origin devices; and
providing the user selected content from the respective origin device to the client device via the mobile intermediate device using the mobile intermediate device address as the source for the content, by using near field connectivity between the mobile intermediate device and the respective geographically proximate origin device from which the user selected content is sourced.

16. The method according to claim 15, wherein the method is performed using the Internet.

17. Software code for a mobile intermediate device, the software code configured to perform the method of claim 15.

18. Software code according to claim 17, wherein the software code is arranged to perform:
processing of a request from the client device, addressed to the mobile intermediate device address, of user selected content from one or more origin devices; and
provision of the user selected content from the respective origin device to the client device via the mobile intermediate device using the mobile intermediate device address as the source for the content, by using near field connectivity between the mobile intermediate device and the respective geographically proximate origin device from which the user selected content is sourced.
